(19) United States
(12) Patent Application Publication
(10) Pub. No.: US 2004/0013471 A1
(43) Pub. Date: Jan. 22, 2004

(54) Subsea pipeline touchdown monitoring

(76) Inventor: David Alexander Matthews, Aberdeen (GB)

Correspondence Address: OSTROLENK FABER GERB & SOFFEN, 1180 AVENUE OF THE AMERICAS, NEW YORK, NY, 100368403

(21) Appl. No.: 10/297,642

(22) PCT Filed: May 29, 2001
(86) PCT No.: PCT/GB01/02366

(30) Foreign Application Priority Data
Jun. 7, 2000 (GB) 001379.0

(51) Int. Cl. F16L 1/00; B63B 35/03

(52) U.S. Cl. 405/154.1

(57) ABSTRACT

A method of monitoring the profile of an underwater pipeline extending between a pipelaying vessel and the seabed comprises deploying multi beam scanning sonar apparatus from the vessel; transmitting acoustic signals from the sonar, detecting return signals reflected from the pipeline; and processing the return signals to obtain a 3-dimensional model of the pipeline and to determine the pipeline touchdown point therefrom. In preferred embodiments, the sonar is located below the vessel on a flexible tether at a depth outside the thruster noise zone of the vessel. Additional sonar apparatus may be used for monitoring the range and bearing of the main sonar relative to the pipeline and its distance above the seabed.

The present invention relates to subsea pipeline monitoring during pipelay operations. More particularly, the invention relates to monitoring the pipeline catenary and touchdown point, and preferably also the seabed topography, during rigid pipelay operations. The invention is particularly, but not exclusively, applicable to pipeline monitoring during deep water (greater than 1500 m in depth) pipelay operations.

During rigid and flexible pipelay operations, knowledge of the precise location at which the pipeline touches down on the seabed (the “touchdown point” or “TDP”) is often required to ensure that the pipeline is laid within a pre-defined seabed corridor, the pipeline is laid within acceptable stress and layback tolerances and to ensure that damage to the pipe or pipe coating is prevented. In deep water, this is particularly important, as sub-surface currents can affect the catenary, resulting in the displacement of the pipeline from it predetermined route. Besides the precise location of the TDP, it would also be desirable to have knowledge of the shape of the pipeline catenary and of the seabed surface topography.

The common, well established technique for monitoring the pipeline TDP is to use a Remotely Operated Vehicle (ROV) deployed from a survey vessel following at a distance behind the pipelay vessel. The ROV is positioned with respect to the survey vessel using its acoustic navigation system. This position is telemetered to the lay vessel from the survey vessel, annotated in real time on the lay vessel's survey display system and subsequently used to manoeuvre the vessel along the pipeline route. However, the costs of having a survey vessel in continuous attendance can be prohibitive and on a lengthy project, can form a large part of the overall budget. Existing systems do not provide good information about the shape of the catenary or the seabed topography.

Consequently, there is a requirement for a system for monitoring the TDP, and preferably also the pipeline catenary and seabed topography, which does not require the use of a survey vessel, whilst maintaining lay accuracy and lay rates, and without increasing the risk to the pipelay operation.

Attempts to monitor a pipeline using an ROV deployed from the lay vessel have resulted in pipelines being positioned out of the lay corridor, reduction in pipelay rates and loss of or damage to the ROV, due to tethers snagging on the pipeline.

U.S. Pat. No. 4,037,189 discloses a pipeline monitoring system in which acoustic signals are transmitted in sequence from a plurality of mutually spaced transducers mounted on a pipelay vessel and are detected by a plurality of sensors spaced along the pipeline. The sensors transmit electrical signals via cables extending along the pipeline between the sensors in response to acoustic signals received from the acoustic transducers. The elapsed time between the transmission of signals by the acoustic transducers and their detection by the pipeline sensors allows the 3-dimensional configuration of the pipeline catenary to be calculated. However, this system requires a relatively large number of pipeline sensors at frequent intervals along the pipeline and also requires cabling along the length of the pipeline with connections to each of the sensors. This system provides limited information about the catenary configuration and is complex and expensive to install and operate.

In accordance with a first aspect of the invention, there is provided a method of monitoring the profile of an underwater pipeline extending between a pipelaying vessel and the seabed, comprising:

deploying first sonar transducer apparatus from the vessel;

transmitting acoustic signals from said first sonar apparatus;

detecting acoustic return signals reflected from said pipeline; and

processing said return signals so as to obtain a 3-dimensional model of said pipeline and to determine the pipeline touchdown point therefrom.

In preferred embodiments, said first sonar transducer apparatus is located below said vessel and is tethered to said vessel by a flexible tether.

In accordance with a second aspect of the invention, there is provided sonar apparatus for monitoring the profile of a pipeline extending between a pipelaying vessel and the seabed and adapted to be deployed below said vessel by means of a flexible tether, the apparatus comprising:

first multi-beam scanning sonar transducer apparatus for monitoring at least part of the pipeline between said vessel and the seabed;

second forward looking sonar transducer apparatus for monitoring the range and bearing of the first sonar transducer apparatus relative to the pipeline; and

third downward looking sonar transducer apparatus comprising for monitoring distance from the first sonar transducer apparatus to the seabed. Other aspects and preferred features of the invention are defined in the claims appended hereto.

The present invention will now be described by way of reference only with reference to the accompanying drawings in which:

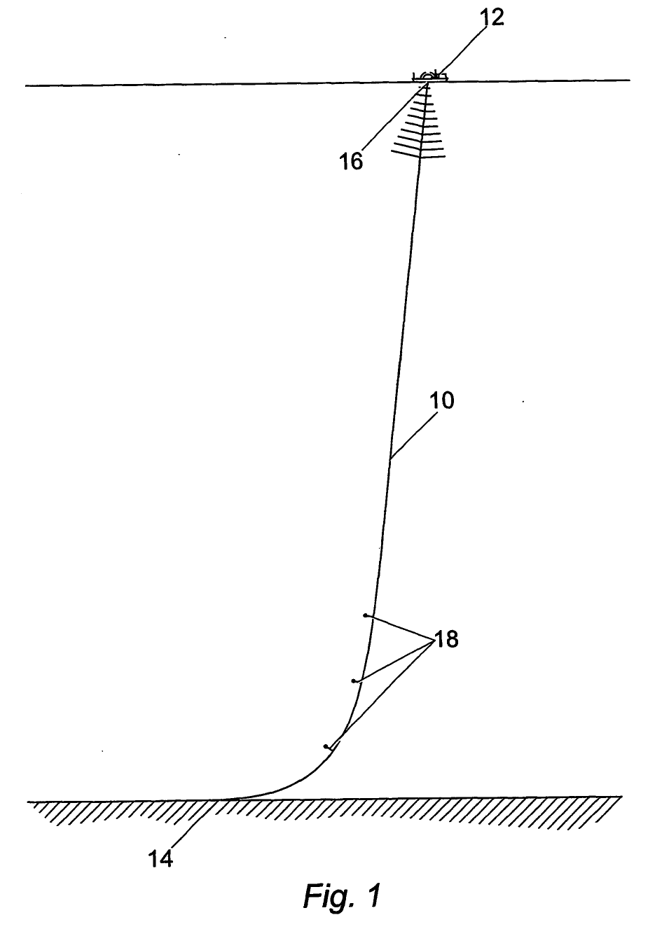

FIG. 1 illustrates a first embodiment of a pipeline monitoring system in accordance with the present invention;

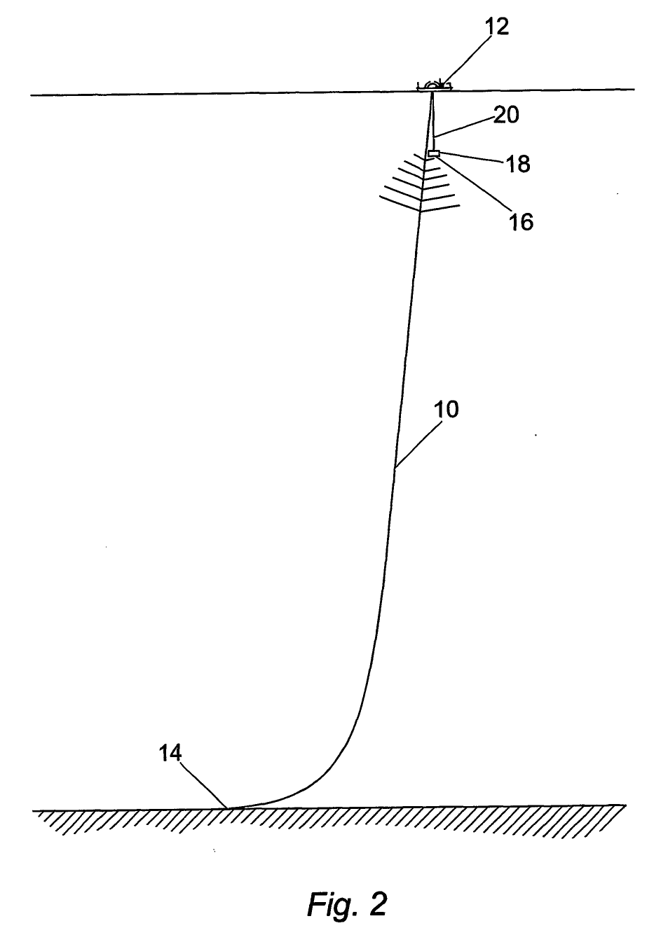

FIG. 2 illustrates a second embodiment of a pipeline monitoring system in accordance with the present invention;

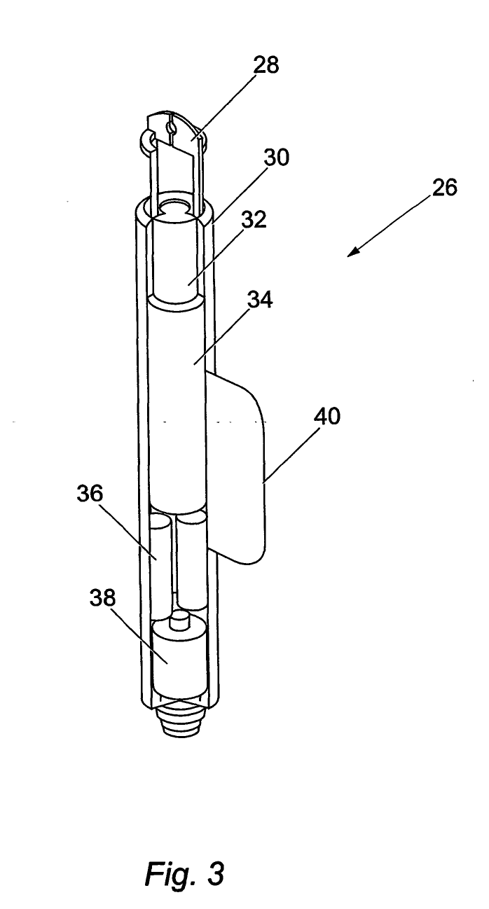

FIG. 3 shows a sonar probe for use in a further embodiment of the present invention;

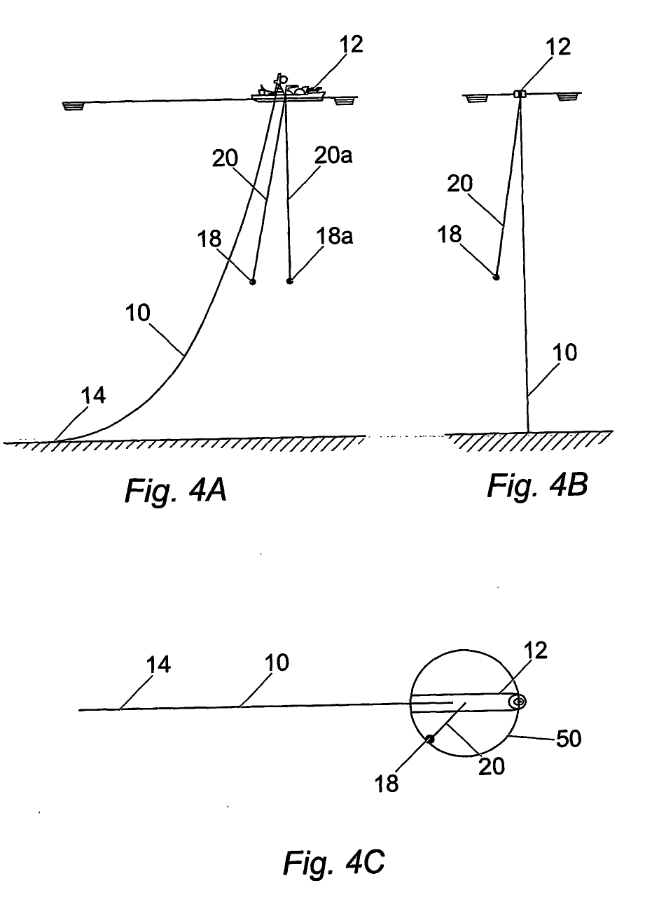

FIGS. 4A, 4B and 4C are, respectively, side, end and plan views illustrating a preferred embodiment of the invention;

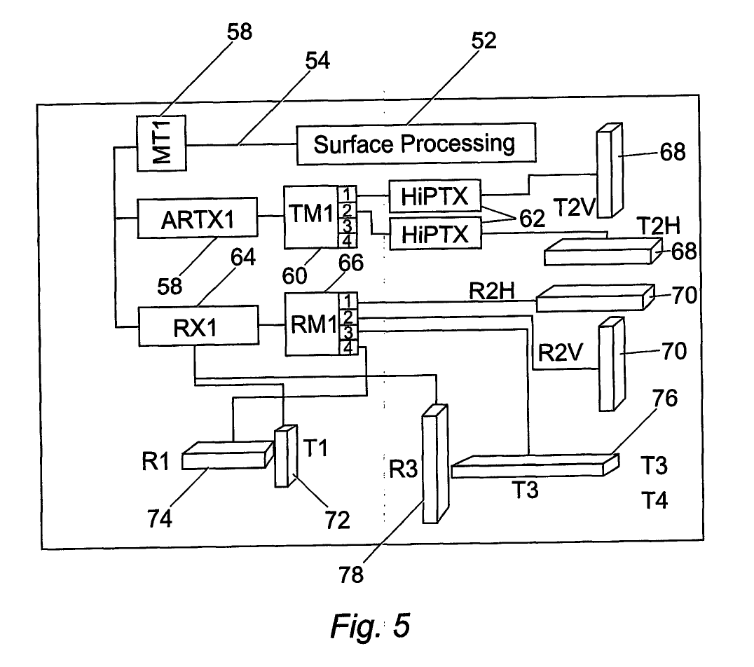

FIG. 5 is a block diagram illustrating a preferred embodiment of a sonar system in accordance with the invention;

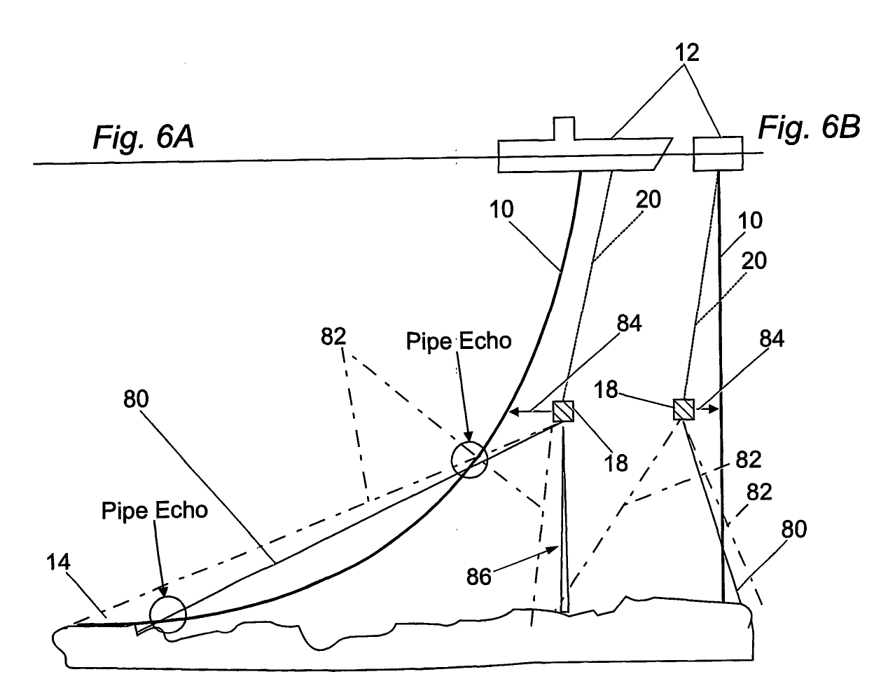

FIGS. 6A and 6B are, respectively, side and end views illustrating the operation of the sonar system of FIG. 5; and

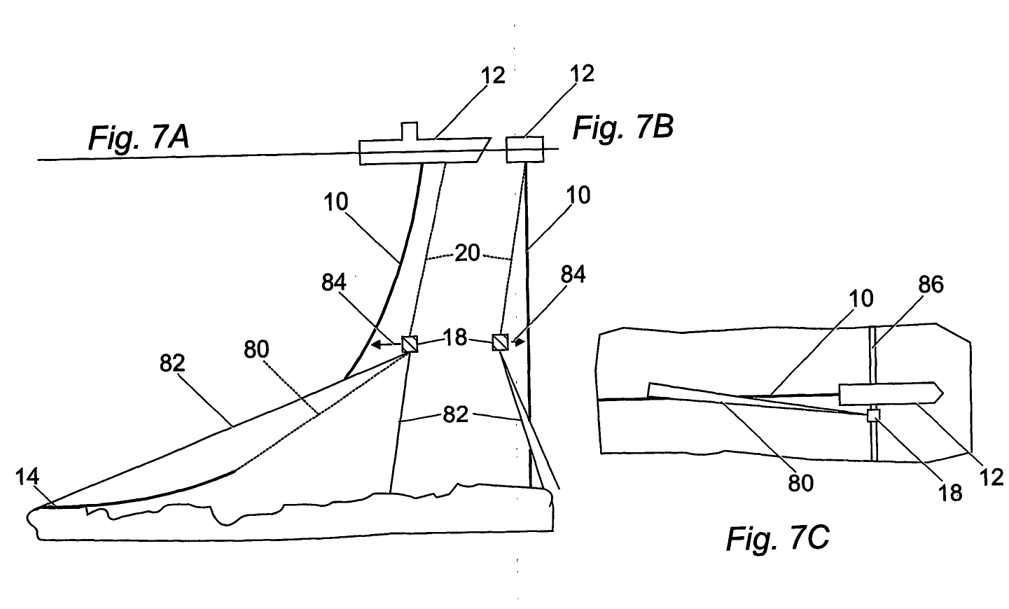

FIGS. 7A, 7B and 7C are, respectively, side, end and plan views illustrating a variation of the embodiment of FIG. 6.

FIG. 1 illustrates a first embodiment of the invention, in which a rigid pipeline 10 is being laid in deep water (e.g. up to about 2500 m) from a pipelay vessel 12. The pipeline 10 forms a catenary curve between the vessel 12 and the pipeline touchdown point (TDP) 14, as is well known in the art. It will be understood that the horizontal distance (“layback”) between the vessel 12 and the TDP 14 varies with the water depth and pipelay angle (i.e. the angle at which the pipeline 10 departs from the vessel 12. In the example shown, with a water depth of 2500 m and a near vertical lay angle, the layback is approximately 600 m.

In accordance with the present invention, the pipeline catenary and touchdown point are monitored by means of a sonar system 16 deployed from the vessel 12. In this embodiment, the sonar transducer array is deployed from a moontube or the like on the vessel 10, so as to be rigidly mounted relative to the vessel, typically positioned directly beneath the hull. The sonar system is arranged to insonify (“illuminate”) at least a portion of the pipeline 10, enabling the pipeline catenary and touchdown point to be monitored on the basis of sonar signals reflected from the pipeline 10. In preferred embodiments, the sonar system is of a type which will enable real-time imaging of the pipeline 10 and of the seabed in the region of and ahead of the TDP 14.

The strength of the transmitted sonar signals reaching the pipeline and of the return signals reflected from the pipeline will depend on the distances between the sonar system 16 and the pipeline. The system may operate up to a certain distance on the basis of simple reflection of transmitted signals from the pipeline. For greater distances, the strength of the return signals may be enhanced by attaching sonar targets 18 to the pipeline at intervals as the pipeline is launched from the vessel. The sonar targets 18 may be used as reference points to verify that the pipeline model derived from the sonar data corresponds to the actual catenary shape. Such sonar targets 18 may comprise passive reflectors, which simply improve the efficiency with which the transmitted sonar signals are reflected from the pipeline, and/or active transponders, which actively generate an amplified return signal in response to detection of the originally transmitted signal. The type of targets employed may be selected to suit the parameters of the sonar system 16 and of the pipelay operation. In general, the system should employ as few targets 18 as possible, and active transponders only where absolutely necessary, in order to minimise costs. The sonar targets 18 may be disposable or could be recoverable by means of automated release mechanisms or ROV intervention.

The pipeline 10 would normally be fitted with anodes at predetermined intervals (typically about 120 m) as the pipe is launched from the vessel. The sonar targets may be fitted at the same time as the anodes and may be configured to have similar dimensions to the anodes (particularly in terms of radial projection from the pipe). The sonar targets might also be combined with anodes as single devices for attachment to the pipeline 10. In this way, the attachment of sonar targets 18 to the pipeline 10 need not have any significant effect on the pipeline laying rate.

A relatively small number of sonar targets 18 at, for example, 120 m intervals, is sufficient to confirm the position of the pipeline between the target locations in combination with relatively low-strength return signals reflected directly from the pipeline between the target locations.

The system allows the pipeline catenary and TDP to be monitored and/or imaged by the following steps:

Actuating the sonar.

Measuring the elapsed time between transmission of the acoustic sonar signals and detection of the return signals reflected from the pipeline 10 and sonar targets 18, and preferably also from the seabed.

Correcting the detected return signals to compensate for vessel pitch, roll and yaw (suitably using pitch, roll and yaw data from the vessel's own sensor systems).

Analysing the detected return signals to obtain a 3-dimensional model of the pipeline catenary and TDP, and preferably also of the seabed topography.

Monitoring and controlling the laying route and the operation of the pipelaying equipment on board the vessel with regard to the catenary shape and TDP position.

For the purposes of the present invention, the sonar system employed is preferably a variable frequency, multi-transducer (beam) sonar system. Most preferably, the sonar system comprises a multi-beam steered scanning sonar system. The sonar signal frequency employed is selected to suit the relevant pipelay depth. A relatively low frequency signal provides greater range for very deep water operations whilst a relatively high frequency provides greater accuracy (resolution). For most applications, suitable signal frequencies are likely to be in the range 30 kHz to 100 kHz, preferably in the range 50 kHz to 60 kHz.

This preferred type of sonar system provides very high resolution bathymetry data from the seabed and the pipeline. A variable frequency multi-beam steered scanning sonar of this type ensures minimal gaps in the sonar coverage, resulting in a continuous scan. The high angular resolution of the system allows precise tracking of the pipeline.

The choice of sonar frequency and the size of the transducer array is directly related to the water depth and range required.

A system of this type may provide a real-time, 3-dimensional digital topography model of the seabed pipelay corridor several hundred metres in advance of the TDP, and may switch between a conventional “survey mode” and a “TDP tracking mode”, in accordance with the invention, instantaneously. Integration of the 3-D digital topography model and the TDP tracking data provides a real-time 3-D model of the pipelay operation, in which the TDP, pipeline catenary shape, the seabed topography and the position and orientation of the pipelay vessel are all quantified. The use of clearly identifiable sonar targets 18 on the pipeline 10 assists in modelling the catenary shape from the overall sonar data, which is particularly helpful where seabed conditions are such that it becomes difficult to ascertain the precise TDP 14.

Given accurate real-time data regarding the catenary shape and TDP, the stress on the pipeline during laying operations can be accurately determined, monitored and controlled.

In these embodiments of the invention, the transmit and receive transducers of the sonar system 16 are suitably configured in a “T” arrangement. Such a transducer array may be too large to be deployed through a typical moon tube. Consequently, the array may require a vertical moon tube deployment mechanism, whereby the array is folded for passage through the moon tube and subsequently opened below the hull. The sonar array may have an ROV fail-safe retrieval mechanism should the array become damaged from below.

In the embodiments of the invention described thus far, the sonar transducers are rigidly mounted in a fixed position below to the vessel. With a fixed arrangement of this nature, the transducers are necessarily located close to the vessel and are likely to be subject to interference from thruster noise and aeration of the water close to the vessel.

In preferred embodiments of the invention, the sonar system is be deployed on a flexible tether (umbilical) extending from the pipelay vessel. This allows the sonar system to be positioned at a greater distance from the vessel, thereby reducing the level of noise generated by the vessel which may affect the operation of the sonar system. That is, the sonar system is deployed outside the thruster noise zone of the vessel, i.e. at such a distance from the vessel that thruster noise is sufficiently low as not to cause any significant interference with the operation of the sonar system. This distance will obviously vary depending on the characteristics of the vessel thrusters and of the sonar system. Such an arrangement reduces or eliminates the need for passive or active sonar targets.

FIG. 2 illustrates an embodiment of this type, in which the sonar system 16 is mounted on an underwater platform 18, which is connected to the vessel 12 by a suitable umbilical 20. The platform 18 may be a general purpose remotely operated vehicle (ROV), a purpose-built ROV, or a garage/tether management system for an ROV. In any case, the platform 18 preferably has its own thrusters to allow control of its position and relative to the pipeline. In embodiments of this type, the platform 18 is preferably deployed at a depth below the vessel which is outwith the thruster noise zone (typically greater than 50 to 100 m), preferably about 500 m above the seabed (where the water depth permits) in order to substantially eliminate the effect of the vessel's thruster noise and to place the sonar system at the optimal depth relative to the pipeline, the seabed and the vessel.

The operation of ROVs etc. at such depths may be problematic. In this case, the sonar system may be mounted on a platform or vehicle as discussed above, or may comprise a self-contained sonar probe which is connected directly to the vessel by an umbilical. FIG. 3 shows an example of such a probe 26.

The probe 26 consists of a lifting padeye 28, for connecting the probe to a cable or the like, and a casing 30 enclosing an acoustic modem transponder 32, an acoustic modem computer 34, power supply (electric storage cells) 36 and sonar head 38. The probe further includes a replaceable fin 40, which allows the probe to “weather vane” and maintain a static heading. The sonar head 38 is preferably capable of 360° rotation. When deployed and activated, the sonar head would typically rotate through 360° during an initial set-up phase of operation and thereafter focus on a suitable angular range centred on the pipeline 10. The use of a probe of this type provides similar functionality to a platform mounted sonar system, but without drag and orientation problems which might be encountered with such a system.

In the preferred embodiments of the invention where the sonar system is deployed remotely from the vessel 12 on a flexible tether, the method comprises substantially the same steps as in the first embodiment, except that it is necessary to determine the position of the sonar system 16 relative to a reference point, suitably the vessel 12 itself. This may be accomplished using the vessel's own navigation/positioning systems, such as Ultra-Short Baseline Acoustic Positioning (USBL) or High Precision Acoustic Positioning (HIPAP) systems, and/or by means of sonar as shall be described further below.

It will be understood that uncertainty about the location of the sonar system 16 relative to the vessel 12 will be reflected in any 3-D model which relies on knowledge of the location of the sonar transducer array.

Particularly preferred embodiments of the invention will now be described with reference to FIGS. 4 to 7 of the drawings.

In order to get the best sonar view of the pipeline, it is also preferred that the sonar system be positioned ahead of the pipeline in the direction of pipelaying, relatively close to the pipeline in the fore and aft direction, and displaced laterally as far as possible to one side of the pipeline. This is illustrated in FIG. 4, where the sonar platform 18 is deployed about 500 m above the seabed in a water depth of about 1000 m and its horizontal position relative to the vessel 12 can be controlled within an excursion radius 50, suitably of about 100 m. FIG. 4A shows the position 18a of the platform if deployed vertically from the vessel 12, and a preferred working position in which the platform 18 is displaced in the aft direction and laterally to one side of the vessel, suitably by about 75 m.

In the preferred embodiments of the invention, the sonar system deployed on the flexible tether 20 may include additional sonar transmitters and receivers for monitoring the position of the sonar system itself, as shown in FIGS. 5 and 6. As shown in FIG. 5, a preferred embodiment of the sonar system includes a surface processing electronics module 52, located on the vessel 12 and an umbilical 54 connecting the surface module 52 to the platform-mounted system components via an interface 56. The sonar components include: a scanning transmitter 58 and multiplexer 60; high power scanning transmitter amplifiers 62; a scanning receiver 64 and multiplexer 66; main scanning transmitter arrays 68 and scanning receiver arrays 70; a second fixed transmitter array 72 and scanning receiver array 74; and a third fixed transmitter array 76 and scanning receiver array 78.

Apart from the main sonar as described above (transmitters 68 and receivers 70, main sonar beam 80, steerable between limits 82 in FIG. 6), the preferred system further includes a relatively short range type forward looking sonar including the second transmitter 72 and receiver 74 (second sonar beam 84 in FIG. 6), suitably with a signal frequency of 160 kHz, for monitoring the position (horizontal range and bearing) of the sonar platform 18 relative to the pipe 10, and a relatively long range type downward looking sonar including the third transmitter 76 and receiver 78 (third sonar beam 86 in FIG. 6), suitably with a signal frequency of 50 kHz, to monitor the position of the sonar platform relative to the seabed and/or to perform a swathe survey of the seabed ahead of the touchdown point.

It is also preferred that the sonar platform 18 has its own thrusters for positioning the platform within the excursion radius 50 and sensors for providing heading, pitch, roll and heave data for the platform, and that the data from the sonar platform 18 is combined with vessel position, heading and motion data, and with catenary information obtained from pipe monitoring systems on board the vessel. The heading, pitch, roll and heave of the platform may be monitored by means of any suitable sensors, such as a fibre optic gyro, accelerometers etc.

In operation, once the sonar platform has been steered into its operating position (at the desired depth and fore/aft and lateral position relative to the pipeline as discussed above), the operator on board the vessel maintains its position and heading relative to the pipeline using the short range forward looking sonar. The forward looking sonar 72, 74, 84 allows accurate range and bearing measurements of the platform 18 relative to the pipeline 10, suitably to within 15 cm at a range of about 100 m. The platform may include an auto-heading control but, in general, constant operator control will be required to maintain position. Optionally, given a sufficiently high range/bearing update rate, an auto-drive system can be employed to maintain the platform 18 in position, and also to provide heading control.

The main sonar system 68, 70, 80 is used to measure the pipe location below the sonar platform, down to and beyond the touchdown point 14, and may also provide concurrent measurements of the seabed adjacent to the pipe. The long range downward looking sonar 76, 78, 86 is used to measure the seabed directly below the platform 18.

The main sonar system beam 80 is steered electronically between its limits 82 to enable all parts of the pipe 10 to be detected. Another similar transmitter may also be provided, operating at right angles, to illuminate most of the pipe on each “ping”; i.e. the sonar transmitters may scan up and down the pipe and also from side to side.

The sequence of measurements is as follows:

All of the sonar beams are operational all the time or as selected. All the data is processed in real time and used to update a three dimensional model of the entire pipe route. The model generated shows the lay vessel, the sonar platform and the pipe in their correct locations. Additional pipe catenary information may be provided by conventional pipe monitoring systems on board the vessel, allowing the catenary and stresses to be calculated and displayed.

It is preferred that survey data for the pipelay route is entered into the model database prior to arriving on site. As the vessel arrives on site it will gather seabed data using the main sonar 68, 70, 80 and the downward looking sonar 76, 78, 86.

The downward looking sonar 76, 78, 86 provides a pre-lay seabed inspection to detect debris or other potential problems on the seabed, and other features such as existing pipelines, which can be correlated with existing available data.

Conventional catenary monitoring systems use data obtained by monitoring a pipeline as it leaves a pipelay vessel to estimate the pipeline catenary between the vessel and the seabed. Using the present invention, a catenary estimate obtained in this way may be compared with the catenary measured by the sonar system of the present invention to produce a difference model which can be monitored and stored and used to cover for any short term loss of data from either source. The actual measurement of the seabed depth can also be used to improve the catenary estimate obtained from the conventional monitoring system. The touchdown point 14 will be generated by the model, which can also produce a cross section of the seabed along the pipelay route, showing the pre-lay seabed depth and the measured vertical position of the pipe.

Users may select multiple viewing points within the model and data can be extracted and displayed in any suitable format to aid the vessel and lay system operators. Displays may be provided in different parts of the vessel linked by a network.

The present invention provides a number of advantages:

Non-intrusive operation;

100% backup;

Not limited by weather;

Not limited by ROV operability or reliability;

Minimised personnel—option to have the survey crew operate the sonar.

Improvements and modifications may be incorporated without departing from the scope of the present invention.

1. A method of monitoring the profile of an underwater pipeline extending between a pipelaying vessel and the seabed, comprising:
deploying first sonar transducer apparatus from the vessel;
transmitting acoustic signals from said first sonar apparatus;
detecting acoustic return signals reflected from said pipeline; and
processing said return signals so as to obtain a 3-dimensional model of said pipeline and to determine the pipeline touchdown point therefrom.

2. A method as claimed in claim 1, wherein said first sonar transducer apparatus comprises a variable frequency multi-transducer (beam) sonar apparatus.

3. A method as claimed in claim 2, wherein said first sonar transducer apparatus comprises a multi-beam steered scanning sonar apparatus.

4. A method as claimed in any claim 2 or claim 3, wherein said first sonar transducer apparatus operates at a signal frequency in the range 30 kHz to 100 kHz.

5. A method as claimed in claim 4, wherein said first sonar transducer apparatus operates at a signal frequency in the range 50 kHz to 60 kHz.

6. A method as claimed in any one of claims 3 to 5, wherein the operating signal frequency of said first sonar transducer is selected as a function of water depth.

7. A method as claimed in any preceding claim, wherein said first sonar transducer apparatus is located below said vessel and rigidly connected thereto.

8. A method as claimed in claim 7, further including monitoring the pitch, roll and yaw of the vessel and wherein the step of processing said return signals includes adjusting said return signals to compensate for the pitch, roll and yaw of the vessel.

9. A method as claimed in any one of claims 1 to 6, wherein said first sonar transducer apparatus is located below said vessel and is tethered to said vessel by a flexible tether.

10. A method as claimed in claim 9, wherein said first sonar transducer apparatus is deployed at a depth below said vessel outside the thruster noise zone of the vessel.

11. A method as claimed in claim 10, wherein the first sonar transducer apparatus is deployed at least 50 m below said vessel.

12. A method as claimed in claim 10 or claim 11, wherein the first sonar transducer apparatus is deployed about 500 m above the seabed.

13. A method as claimed in any of claims 9 to 12, wherein said first sonar transducer apparatus is mounted on an underwater platform and said underwater platform is tethered to said vessel, said underwater platform including thrusters for controlling the position of the platform.

14. A method as claimed in claim 13, including controlling the horizontal position of said platform such that the platform is laterally displaced to one side of said vessel.

15. A method as claimed in any one of claims 9 to 14, wherein second and third sonar transducer apparatus are deployed along with said first sonar transducer apparatus, said second sonar transducer apparatus comprising forward looking transducer apparatus for monitoring the range and bearing of the first sonar transducer apparatus relative to the pipeline and said third sonar transducer apparatus comprising downward looking sonar for monitoring distance from the first sonar transducer apparatus to the seabed.

16. A method as claimed in claim 15, wherein said third sonar transducer apparatus is operable for modelling the seabed ahead of the pipeline touchdown point.

17. A method as claimed in any one of claims 9 to 16, further including the step of determining the position of said first sonar transducer apparatus relative to the vessel.

18. A method as claimed in claim 17, further including monitoring the pitch, roll and yaw of the first sonar transducer apparatus and wherein the step of processing said return signals includes adjusting said return signals to take account of the position of the first sonar transducer apparatus relative to said vessel and to compensate for the pitch, roll and yaw of the first sonar transducer apparatus.

19. A method as claimed in any preceding claim, further including detecting acoustic return signals reflected from the seabed, deriving a 3-dimensional seabed topography model therefrom and combining said 3-dimensional pipeline model therewith.

20. Sonar apparatus for monitoring the profile of a pipeline extending between a pipelaying vessel and the seabed and adapted to be deployed below said vessel by means of a flexible tether, the apparatus comprising:
first multi-beam scanning sonar transducer apparatus for monitoring at least part of the pipeline between said vessel and the seabed;
second forward looking sonar transducer apparatus for monitoring the range and bearing of the first sonar transducer apparatus relative to the pipeline; and
third downward looking sonar transducer apparatus comprising for monitoring distance from the first sonar transducer apparatus to the seabed.

21. Apparatus as claimed in claim 20, wherein said first, second and third sonar transducer apparatus is mounted on an underwater platform having thrusters for controlling the position of the platform.

22. Apparatus as claimed in claim 20 or 21, further including sensors for sensing the heading, pitch, roll and heave of the apparatus.
